(19) United States
(12) Patent Application Publication
(10) Pub. No.: US 2015/0097749 A1
(43) Pub. Date: Apr. 9, 2015

(54) DUAL BAND DIPOLE ANTENNA FOR UNIVERSAL LTE WIRELESS COMMUNICATION

(71) Applicant: PC-TEL, Inc., Bloomingdale, IL (US)

(72) Inventors: Jin Hao, Palatine, IL (US); Calin Pod, Crystal Lake, IL (US)

(21) Appl. No.: 14/507,004

(22) Filed: Oct. 6, 2014

Related U.S. Application Data
(60) Provisional application No. 61/888,276, filed on Oct. 8, 2013.

(51) Int. Cl. H01Q 21/30; H01Q 9/06

(52) U.S. Cl. CPC H01Q 21/30; H01Q 9/065
USPC 343/810

(57) ABSTRACT

A dual band dipole antenna for universal LTE wireless communication is provided. The antenna can include first, second, and third dipoles etched on a single printed circuit board, wherein each of the first, second, and third dipoles have respective resonance lengths and operate in respective frequency ranges so that the antenna, as a whole, operates in a first frequency range of from approximately 690 MHz to approximately 960 MHz and in a second frequency range of from approximately 1710 MHz to approximately 2800 MHz. For example, the first dipole can operate at frequencies from approximately 690 MHz to approximately 800 MHz and from approximately 1710 MHz to approximately 2700 MHz, the second dipole can operate at frequencies from approximately 800 MHz to approximately 960 MHz and at approximately 1900 MHz, and the third dipole can operate at frequencies from approximately 2000 MHz to approximately 2400 MHz.

### CROSS-REFERENCE TO RELATED APPLICATIONS

This application claims priority to U.S. Provisional Patent Application No. 61/888,276 filed Oct. 8, 2013 and titled “Dual Band Dipole Antenna for Universal LTE Wireless Communication”. U.S. Application No. 61/888,276 is hereby incorporated by reference.

### FIELD

The present invention relates generally to antennas and telecommunications. More particularly, the present invention relates to a dual band dipole antenna for universal LTE (Long-Term Evolution) wireless communication.

### BACKGROUND

Many known dipole antennas operate in frequency ranges used in only one region of the world. For example, some known dipole antennas operate in frequency ranges used only in the United States, that is, in a first, low frequency range of from approximately 824 MHz to approximately 960 MHz and in a second, high frequency range of from approximately 1710 MHz to approximately 1990 MHz. However, this is undesirable because the antennas cannot be universally used worldwide.

Furthermore, many known dipole antennas require three pieces of printed circuit board (PCB). However, this is undesirable from both a cost and manufacturing perspective. Additionally, the use of three PCBs requires complicated PCB structures to extend the bandwidth of an antenna.

Still further, many known dipole antennas require a large ground plane and/or include a ground-plane dependent monopole. However, neither of these solutions is feasible or practical in many situations and applications, including when the antenna is pole mounted.

In view of the above, there is a need for an improved antenna.

### BRIEF DESCRIPTION OF THE DRAWINGS

FIG. 1A is a side view of an antenna in accordance with disclosed embodiments;

FIG. 1B is a first cross-sectional view of an antenna in accordance with disclosed embodiments;

FIG. 1C is a second cross-sectional view of an antenna in accordance with disclosed embodiments;

FIG. 2 is a schematic view of the front and back of a printed circuit board in accordance with disclosed embodiments;

FIG. 3 is a top view of the front of a printed circuit board in accordance with disclosed embodiments;

FIG. 4 is a bottom view of the back of a printed circuit board in accordance with disclosed embodiments;

FIG. 5 is a schematic diagram of a feeding mechanism in accordance with disclosed embodiments.

FIG. 6A is a top view of an antenna base in accordance with disclosed embodiments;

FIG. 6B is a side view of an antenna base in accordance with disclosed embodiments;

FIG. 6C is a cross-sectional view of an antenna base in accordance with disclosed embodiments; and

FIG. 7 is a graph of an exemplary standing wave ratio for an antenna in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a dual band dipole antenna for universal LTE wireless communication. Indeed, in some embodiments, the antenna disclosed herein can operate in LTE frequency ranges that are used worldwide and/or that are used in Europe, Asia, and the United States.

In accordance with the above, in some embodiments, the antenna disclosed herein can operate in two frequency ranges: (1) a first, low frequency range of from approximately 690 MHz to approximately 960 MHz, and (2) a second, high frequency range of from approximately 1710 MHz to approximately 2800 MHz. Accordingly, the antenna disclosed herein can replace known dipole antennas that operate in frequency ranges used only in the United States. Furthermore, the antenna disclosed herein can achieve a desired performance while still being cost effective to manufacture and operate.

In accordance with disclosed embodiments, the antenna disclosed herein can include at least (1) a radiator that includes a single PCB with three dipoles disposed and/or etched thereon, (2) a feeding mechanism, and (3) an antenna base. Each dipole can operate in a respective frequency range and have a respective resonance length. Accordingly, the combination of the three dipoles can form a super wide band antenna.

A first dipole of the antenna disclosed herein can have a single arm that has a first length, a second dipole of the antenna disclosed herein can two arms, each arm of the second dipole having a second length, and a third dipole of the antenna disclosed herein can two arms, each arm of the third dipole having a third length. In some embodiments, the first length can be longer than both the second and third lengths, and in some embodiments, the second length can be longer than the third length.

In some embodiments, the first length can be from approximately 73 mm to approximately 88 mm, and in some embodiments, the first dipole can be resonant in two frequency ranges: (1) a first frequency range that is in a low band of a low frequency range of the antenna, and (2) a second frequency range that is in the high frequency range of the antenna. Accordingly, in some embodiments, the first frequency range of the first dipole can be from approximately 690 MHz to approximately 800 MHz, and the second frequency range of the first dipole can be from approximately 1710 MHz to approximately 2700 MHz.

In some embodiments, the second length can be from approximately 73 mm to approximately 88 mm, and in some embodiments, the second dipole can be resonant in two frequency ranges: (1) a first frequency range that is in a high band of a low frequency range of the antenna, and (2) a second frequency that is in the high frequency range of the antenna. Accordingly, in some embodiments, the first frequency range of the second dipole can be from approximately 800 MHz to approximately 960 MHz, and the second frequency of the second dipole can be approximately 1900 MHz.

In some embodiments, the third length can be from approximately 30 mm to approximately 38 mm, and in some embodiments, the third dipole can be resonant in one frequency range that is in the high frequency range of the antenna. Accordingly, in some embodiments, the frequency range of the third dipole can be from approximately 2000 MHz to approximately 2400 MHz.

In accordance with disclosed embodiments, the feeding mechanism of the antenna disclosed herein can include a microstrip feed line that can be used to tune and match the performance of the antenna.

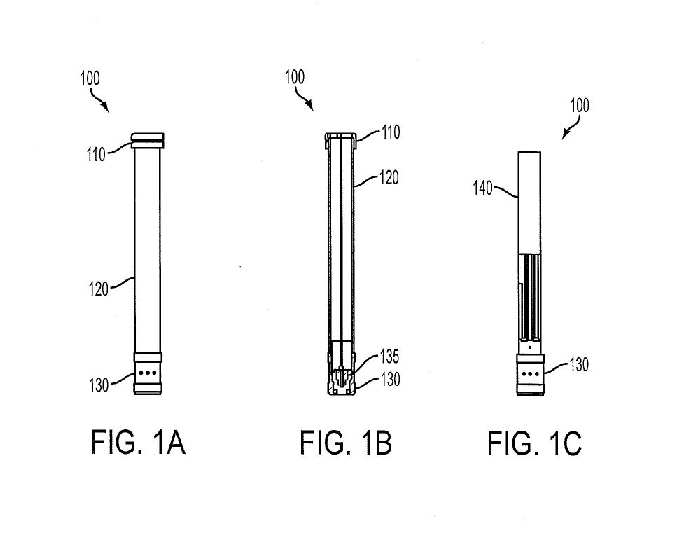

FIG. 1A is a side view of an antenna 100 in accordance with disclosed embodiments, FIG. 1B is a first cross-sectional view of the antenna 100, and FIG. 1C is a second cross-sectional view of the antenna 100. As seen, the antenna 100 can include an antenna cap 110, a radome 120, an antenna base 130, and a PCB 140 that can be housed within the radome 120 and connect with and/or coupled to a connecting receptacle 135 of the base 130.

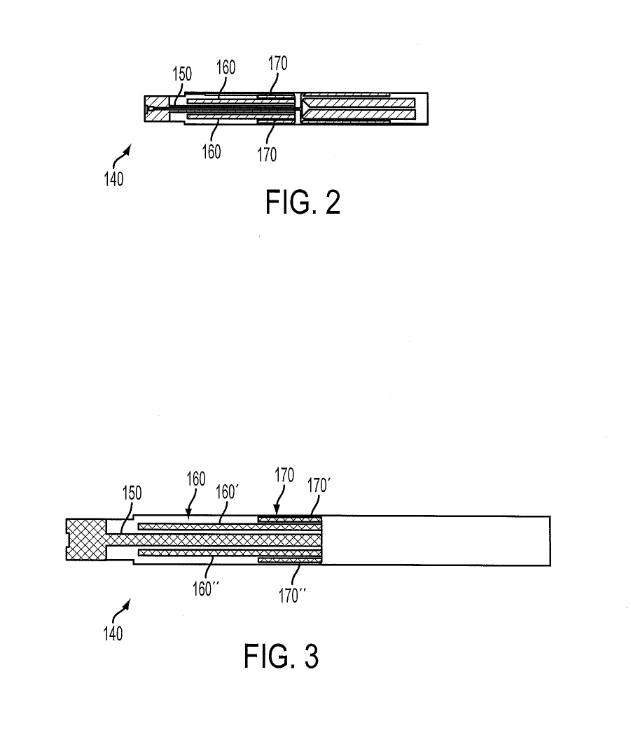

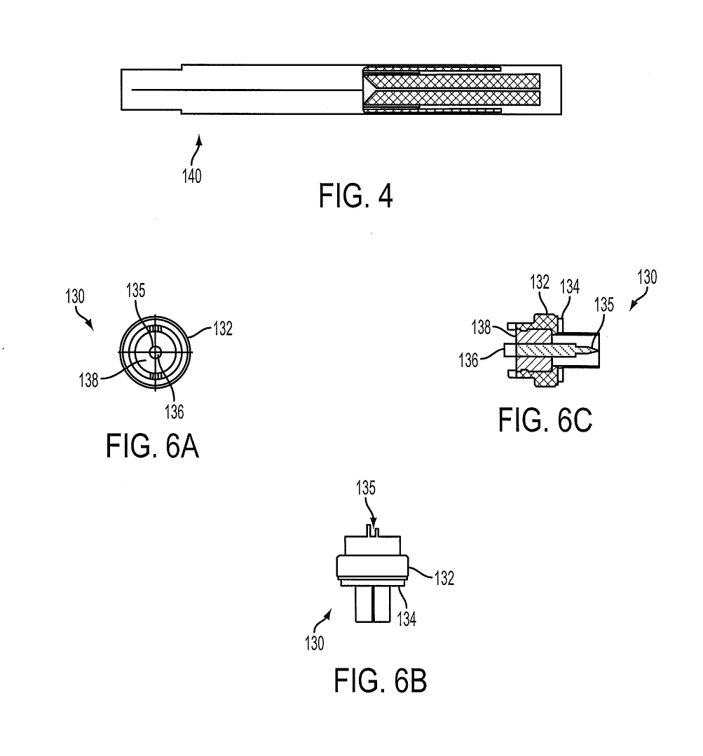

FIG. 2 is a schematic view of the front and back of the PCB 140 in accordance with disclosed embodiments, FIG. 3 is a top view of the front of the PCB 140, and FIG. 4 is a bottom view of the back of the PCB 140. In use, the PCB 140 shown in FIG. 2 can be folded in half so that the front and back of the radiator are on opposing sides of the PCB 140.

As seen in the figures and as described above, first, second, and third dipoles 150, 160, 170, respectively can be disposed and/or etched onto the PCB 140. The first dipole 150 can include a single arm that is the longest of the arms disposed on the PCB. The second dipole 160 can include two arms 160′, 160″, each arm 160′, 160″ of the second dipole 160 being shorter than the single arm of the first dipole 150. The third dipole 170 can include two arms 170′, 170″, each arm 170′, 170″ of the third dipole 170 being shorter than both the single arm of the first dipole 150 and the arms 160′, 160″ of the second dipole 160.

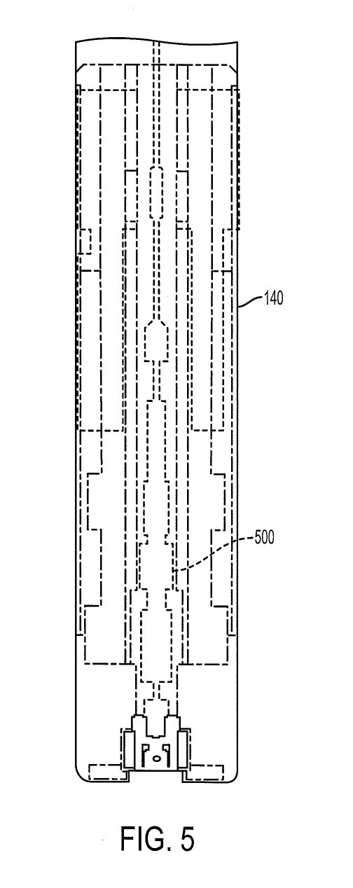

FIG. 5 is a schematic diagram of a feeding mechanism 500 in accordance with disclosed embodiments. As explained above, the feeding mechanism 500 of the antenna 100 disclosed herein can include a microstrip feed line that can be used to tune and match the performance of the antenna 100. For example, the exemplary microstrip feed line 500 shown in FIG. 5 can match a standard 50 Ohm line, and patches can vary depending a plurality of different factors, including the radome 120, the material of the PCB 140, the size and thickness of the PCB 140, the connection between the PCB 140 and the antenna base 130 at the connecting receptacle 135, and the like.

In some embodiments, the PCB 140 can have a width of from approximately 15 mm to approximately 25 mm, and in some embodiments, the width of the PCB 140 can be approximately 20 mm. In some embodiments, the PCB 140 can have a thickness that is in accordance with known standard thicknesses for PCBs. For example, the thickness of the PCB 140 can be approximately 0.762 mm, 1.524 mm, 2.362 mm, or any other thickness as would be known and desired by those of skill in the art, including a thickness less than approximately 5 mm.

FIG. 6A is a top view of the antenna base 130 in accordance with disclosed embodiments, FIG. 6B is a side view of the antenna base 130, and FIG. 6C is a cross-sectional view of the antenna base 130. As seen, the base 130 can include an end cap 132, a sealing gasket 134, and a connecting receptacle 135 for receiving a connecting pin 136 that couples with the PCB 140 and the dipoles 150, 160, 170 disposed thereon. The connecting pin 136 can be surrounded, at least in part, by a dielectric material 138.

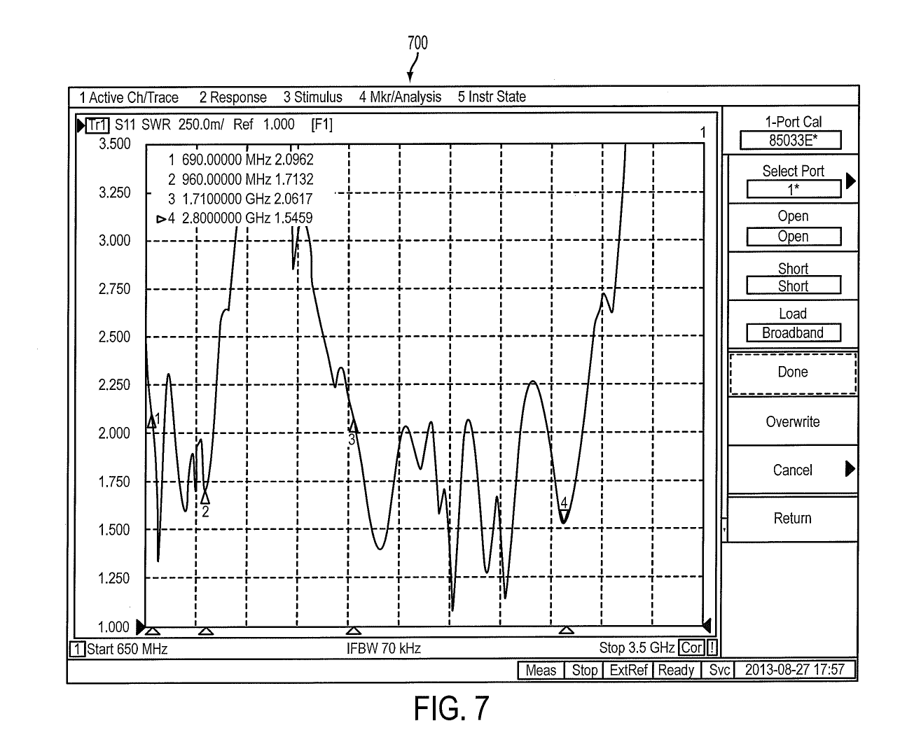

Finally, FIG. 7 is a graph 700 of an exemplary standing wave ratio for the antenna 100 disclosed herein. As seen in FIG. 7, the antenna 100 can have a VSWR of approximately 2.0962 at approximately 690 MHz, a VSWR of approximately 1.7132 at approximately 960 MHz, a VSWR of approximately 2.0617 at approximately 1710 MHz, and a VSWR of approximately 1.5459 at approximately 2800 MHz.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. An antenna comprising:
a single printed circuit board; and
first, second, and third dipoles etched on the single printed circuit board,
wherein the antenna operates in first and second frequency bands, the first band including a first range of frequencies and the second band including a second range of frequencies.

2. The antenna of claim 1 wherein the first and second frequency bands encompass worldwide LTE frequency ranges.

3. The antenna of claim 1 wherein the first range of frequencies is from approximately 690 MHz to approximately 960 MHz.

4. The antenna of claim 1 wherein the second range of frequencies is from approximately 1710 MHz to approximately 2800 MHz.

5. The antenna of claim 1 wherein the first dipole has a first resonance length, the second dipole has a second resonance length, and the third dipole has a third resonance length, and wherein the first resonance length is longer than the second resonance length and the third resonance length.

6. The antenna of claim 5 wherein the second resonance length is longer than the third resonance length.

7. The antenna of claim 1 wherein the first dipole operates in a first, first dipole frequency range and in a second, first dipole frequency range, wherein the first, first dipole frequency range is within the first range of frequencies, and wherein the second, first dipole frequency range is within the second range of frequencies.

8. The antenna of claim 7 wherein the first, first dipole frequency range is within a low band of the first range of frequencies.

9. The antenna of claim 7 wherein the first, first dipole frequency range is from approximately 690 MHz to approximately 800 MHz.

10. The antenna of claim 7 wherein the second, first dipole frequency range is from approximately 1710 MHz to approximately 2700 Mhz.

11. The antenna of claim 1 wherein the second dipole operates in a first, second dipole frequency range and at a second, second dipole frequency, wherein the first, second dipole frequency range is within the first range of frequencies, and wherein the second, second, dipole frequency is within the second range of frequencies.

12. The antenna of claim 11 wherein the first, second dipole frequency range is within a high band of the first range of frequencies.

13. The antenna of claim 11 wherein the first, second dipole frequency range is from approximately 800 MHz to approximately 960 MHz.

14. The antenna of claim 11 wherein the second, second dipole frequency is approximately 1900 MHz.

15. The antenna of claim 1 wherein the third dipole operates in a third dipole frequency range, and wherein the third dipole frequency range is within the second range of frequencies.

16. The antenna of claim 15 wherein the third dipole frequency range is from approximately 2000 MHz to approximately 2400 MHz.

17. An antenna comprising:
first, second, and third dipoles etched on a single printed circuit board,
wherein each of the first, second, and third dipoles have respective resonance lengths and operate in respective frequency ranges so that the antenna, as a whole, operates in a first frequency range of from approximately 690 MHz to approximately 960 MHz and in a second frequency range of from approximately 1710 MHz to approximately 2800 MHz.

18. An antenna comprising:
first, second, and third dipoles etched on a single printed circuit board,
wherein the first dipole operates in a first, first dipole frequency range of from approximately 690 MHz to approximately 800 MHz and in a second, first dipole frequency range of from approximately 1710 MHz to approximately 2700 MHz,
wherein the second dipole operates in a first, second dipole frequency range of from approximately 800 MHz to approximately 960 MHz and at a second, second dipole frequency of approximately 1900 MHz, and
wherein the third dipole operates in a third dipole frequency range of from approximately 2000 MHz to approximately 2400 MHz.
